(19) United States
(12) Patent Application Publication
(10) Pub. No.: US 2014/0201680 A1
(43) Pub. Date: Jul. 17, 2014

(54) SPECIAL CHARACTER INPUT METHOD AND ELECTRONIC DEVICE THEREFOR

(71) Applicant: Samsung Electronics Co., Ltd, Gyeonggi-do (KR)

(72) Inventors: Jung-Woo Lee, Gyeonggi-do (KR); Myung-Su Kang, Seoul (KR); Jae-Wan Cho, Gyeonggi-do (KR); Soon-Hyun Cha, Seoul (KR); Sun-Min Hwang, Gyeonggi-do (KR)

(73) Assignee: Samsung Electronics Co., Ltd, Gyeonggi-do (KR)

(21) Appl. No.: 14/152,774

(22) Filed: Jan. 10, 2014

(30) Foreign Application Priority Data
Jan. 11, 2013 (KR) 10-2013-0003399

(51) Int. Cl. G06F 3/0482; G06F 3/0481

(52) U.S. Cl. CPC G06F 3/0482; G06F 3/04817
USPC 715/835

(57) ABSTRACT

A method and apparatus for inputting special characters which are paired in an electronic device. The method includes detecting input of at least one first special character, determining at least one second special character corresponding to the at least one first special character, displaying the at least one second special character, and inputting the at least one second special character when selection of the at least one special character is sensed.

### PRIORITY

The present application is related to and claims the benefit under 35 U.S.C. §119(a) of a Korean patent application filed in the Korean Intellectual Property Office on Jan. 11, 2013 and assigned Serial No. 10-2013-0003399, the entire disclosure of which is hereby incorporated by reference.

### TECHNICAL FIELD

The present disclosure relates to a method and apparatus for inputting special characters in an electronic device.

### BACKGROUND

Each of electronic devices, which has become necessities of modern people due to ease in carrying it, has been developed into each of multimedia devices which provides various services such as a voice and video communication service, a message transmission and reception service, an information input and output service, and a data storage service.

Particularly, the message transmission and reception service is a service for transmitting and receiving a short sentence about 40 words between electronic devices without separate additional equipment. The message transmission and reception service is known as a text message service or a Short Message Service (SMS). The message service has an advantage in that the message service may be simplified in use, contents may be transmitted quickly, and the message service may be used that it is impossible to perform voice communication. Recently, while the use of smart phones has been increased, there has been a notably growing trend towards a messenger service which may be installed and used in each of the smart phones by users in addition to the message service provided from a communication service provider.

As described above, as the use of the message service and the messenger service is increased, the number of times that a user of the electronic device inputs characters using a keypad is also increased. When the user inputs characters using the keypad, he or she inputs special characters as well as text. Herein, the special characters may include symbols except for numerals, alphabetic characters, and Hangul. For example, the special characters may be +, −, /, *, #, =, (, ), %, “, etc. When the user of the electronic device inputs special characters, he or she may need to change an input mode from a text input mode to a special character input mode, and search and select desired special characters in the special character input mode. For example, when the user inputs “( [symbol] )”, he or she may need to perform a process of changing an input mode from a Hangul input mode to a special character input mode, changing a current page to a page including a “(”, inputting the “(”, changing the special character input mode to the Hangul input mode, inputting a “ [symbol] ”, changing the Hangul input mode to the special character input mode, changing a current page to a page including a “)”, and inputting the “)”.

As described above, in order to input special characters in the electronic device, it is necessary for the user to perform a plurality of operations. Therefore, an interface for easily inputting special characters is needed in the electronic device.

### SUMMARY

To address the above-discussed deficiencies of the prior art, it is a primary object to provide a method and apparatus for inputting special characters in an electronic device.

Another aspect of the present disclosure is to provide a method and apparatus for inputting special characters which are paired in an electronic device.

Another aspect of the present disclosure is to provide a method and apparatus for displaying an icon for inputting special characters which are paired in an electronic device.

In accordance with an aspect of the present disclosure, a method of inputting special characters in an electronic device is provided. The method includes detecting input of at least one first special character, determining at least one second special character corresponding to the at least one first special character, displaying the at least one second special character (or displaying an icon for inputting the at least one second special character), and inputting the at least one second special character when selection of the at least one second special character is sensed (or inputting the at least one second special character when selection of the icon is sensed).

In accordance with another aspect of the present disclosure, a method of inputting special characters in an electronic device is provided. The method includes detecting input of at least one first special character, determining at least one second special character corresponding to the at least one first special character, inputting the at least one second special character, and displaying a cursor between the at least one first special character and the at least one second special character.

In accordance with another aspect of the present disclosure, an electronic device is provided. The electronic device includes at least one processor, at least one memory, and at least one program which is stored in the at least one memory and is configured to be executable by the at least one processor, wherein the at least one processor detects input of at least one first special character, determines at least one second special character corresponding to the at least one first special character, displays the at least one second special character (or displays an icon for inputting the at least one second special character), and inputs the at least one second special character when selection of the at least one second special character is sensed (or inputs the at least one second special character when selection of the icon is sensed).

In accordance with another aspect of the present disclosure, an electronic device is provided. The electronic device includes at least one processor, at least one memory, and at least one program which is stored in the at least one memory and is configured to be executable by the at least one processor, wherein the at least one processor detects input of at least one first special character, determines at least one second special character corresponding to the at least one first special character, inputs the at least one second special character, and displays a cursor between the at least one first special character and the at least one second special character.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device according to one embodiment of the present disclosure;

FIG. 2 illustrates a block diagram of a processor according to one embodiment of the present disclosure;

FIG. 3A illustrates a flowchart of a process for inputting special characters which are paired in an electronic device according to one embodiment of the present disclosure;

FIG. 3B illustrates a block diagram of an electronic device for inputting special characters which are paired according to one embodiment of the present disclosure;

FIG. 4 illustrates a flowchart of a process for inputting special characters which are paired in an electronic device according to another embodiment of the present disclosure;

FIG. 5 illustrates a flowchart of a process for inputting special characters which are paired in an electronic device according to another embodiment of the present disclosure;

FIGS. 6A to 6K illustrate processes for inputting special characters which are paired in an electronic device according to one embodiment of the present disclosure; and

FIG. 7 illustrates a flowchart of a process for inputting special characters which are paired in an electronic device according to another embodiment of the present disclosure.

### DETAILED DESCRIPTION

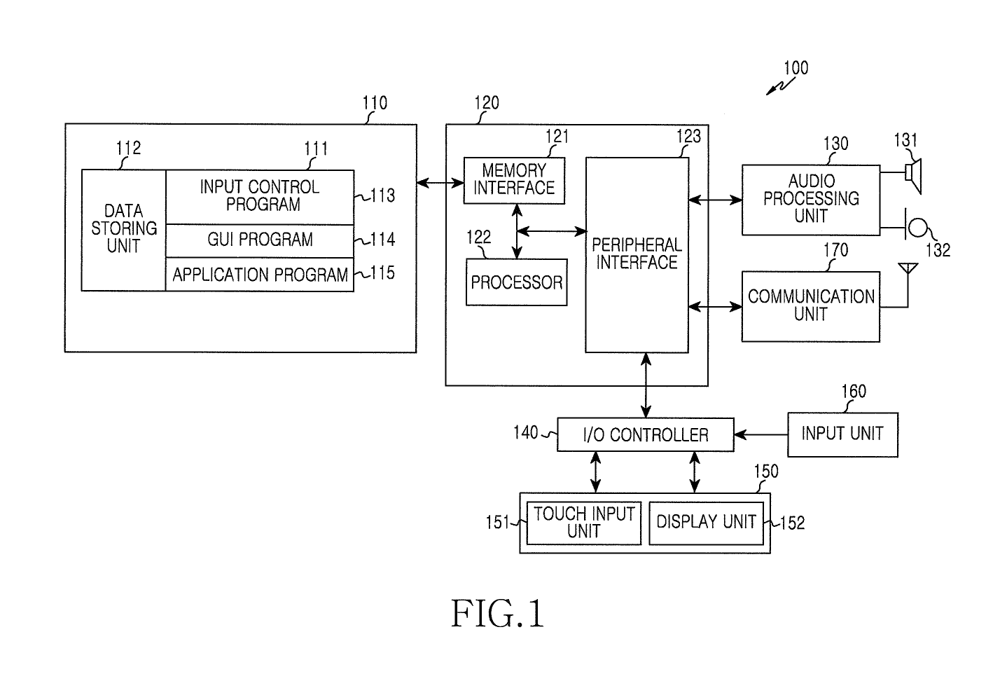

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Exemplary embodiments of the present disclosure will be described herein below with reference to the accompanying drawings. In the following description, well-known functions or constructions are not described in detail since they would obscure the disclosure in unnecessary detail.

Hereinafter, a description will be given for a method and apparatus for inputting special characters which are paired in an electronic device. Herein, the special characters which are paired may include at least one of special characters which are paired and used, such as ( ), { }, [ ], [ ], < >, < >, <0>, “ ”, ‘ ’, [symbol] , and [symbol] .

Hereinafter, the electronic device may be any one of a mobile communication terminal, a Personal Digital Assistant (PDA), a laptop, a smart phone, a netbook, a television, a Mobile Internet Device (MID), a Ultra Mobile Personal Computer (UMPC), a tablet PC, a smart TV, a navigation device, and a Moving Picture Experts Group (MPEG) layer 3 (MP3) player, which have a touch screen.

The present disclosure relates to a method and apparatus for inputting special characters which are paired in an electronic device.

FIG. 1 illustrates a block diagram of an electronic device having a touch screen according to one embodiment of the present disclosure.

As shown in FIG. 1, the electronic device denoted by 100 may include a memory 110, a processor unit 120, an audio processing unit 130, an Input/Output (I/O) controller 140, a touch screen 150, an input unit 160, and a communication unit 170. Herein, the memory 110 may be a plurality of memories.

A description will be given for respective components as follows.

The memory 110 may include a program storing unit 111 for storing programs for controlling operations of the electronic device 100 and a data storing unit 112 for storing data generated while the programs are executed. The program storing unit 111 includes an input control program 113, a Graphic User Interface (GUI) program 114, and at least one application program 115. Herein, the programs included in the program storing unit 111 may be expressed in an instruction set as a set of instructions.

The input control program 113 may include at least one software component for inputting special characters in an application program. For one example, when input of a first special character is detected, the input control program 113 determines a second special character corresponding to the first special character. Thereafter, the input control program 113 performs a control operation to display an icon for inputting the second special character (or display the second special character) through the GUI program 114. If selection of the icon (or the second special character) is sensed, the input control program 113 inputs the second special character. For another example, when the input of the first special character is detected, the input control program 113 determines the second special character corresponding to the first special character. Thereafter, the input control program 113 performs the control operation to display the icon for inputting the second special character through the GUI program 114. After the icon is displayed, when input of a third character is detected, the input control program 113 releases the display of the icon. Herein, when the input of the third character is not detected during a reference time, the input control program 113 displays the icon again.

In addition, when the input of the third character is not detected and the icon is selected, the input control program 113 may locate a cursor between the first special character and the second special character.

The GUI program 114 may include at least one software component for providing a UI as graphics on a display unit 152. For one example, when input of a virtual keyboard is generated through the input control program 113, the GUI program 114 performs a control operation to display an input special character on the display unit 152. For another example, the GUI program 114 may perform a control operation to display an icon for inputting special characters on the display unit 152. For another example, the GUI program 114 may perform a control operation to display the number of the same characters on the display unit 152.

The application program 115 may include a software component for at least one application program installed in the electronic device 100.

The processor unit 120 may include a memory interface 121, at least one processor 122, and a peripheral interface 123. Herein, when the memory interface 121, the at least one processor 122, and the peripheral interface 123 which are included in the processor unit 120 may be integrated in at least one Integrated Circuit (IC) or be separately implemented.

The memory interface 121 controls that a component like the processor 122 or the peripheral interface 123 accesses the memory 110.

The peripheral interface 123 controls connection among an I/O peripheral of the electronic device 100, the processor 122, and the memory interface 121.

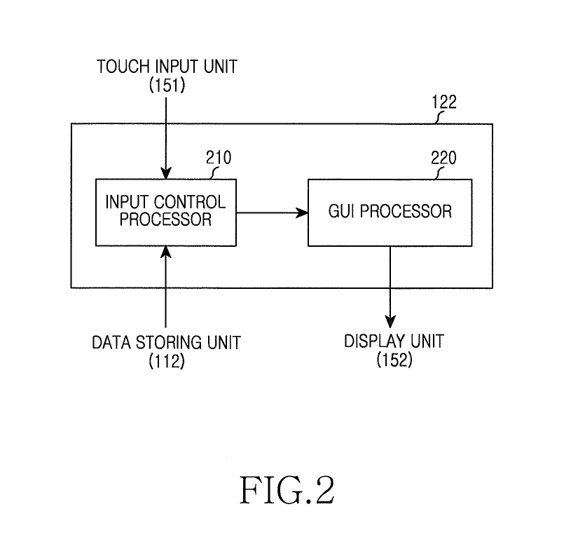

The processor 122 provides a variety of multimedia services using at least one software program. Also, the processor 122 executes at least one program stored in the memory 110 and provides a service according to the corresponding program. For example, the processor 122 may be, as shown in FIG. 2, configured to execute the input control program 113 and control input of special characters.

The audio processing unit 130 provides an audio interface between a user and the electronic device 100 through a speaker 131 and a microphone 132.

The I/O controller 140 provides an interface between I/O devices, such as the touch screen 150 and the input unit 160, and the peripheral interface 123.

The touch screen 150 is an input and output device for inputting and outputting information. The touch screen 150 may include a touch input unit 151 and the display unit 152.

The touch input unit 151 provides touch information sensed through a touch panel to the processor unit 120 through the I/O controller 140. That is, the touch input unit 151 provides touch information by an electronic pen or a finger of the user to the processor unit 120 through the I/O controller 140.

The display unit 152 displays at least one of state information of the electronic device 100, characters input by the user, moving pictures, still pictures, etc. For one example, the display unit 152 displays special character data provided from the GUI program 114. For another example, the display unit 152 may display an icon for inputting special characters provided from the GUI program 114. For another example, the display unit 152 may display the number of the same special characters provided from the GUI program 114.

The input unit 160 provides input data generated by selection of the user to the processor unit 120 through the I/O controller 140. For one example, the input unit 160 includes only a control button for control of the electronic device 100. For another example, the input unit 160 may be configured as a keypad for receiving input data from the user.

The communication unit 170 may include a communication system for performing a communication function for voice communication and data communication. Herein, the communication unit 170 may be classified into a plurality of communication sub-modules which support different communication networks. For example, the communication network may be, but is not limited to, any one of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a Bluetooth network, a Near Field Communication (NFC) network.

FIG. 2 illustrates a block diagram of a processor according to one embodiment of the present disclosure.

As shown in FIG. 1 and FIG. 2, the processor 122 may include an input control processor 210 and a GUI processor 220.

The input control processor 210 executes the input control program 113 of the program storing unit 111 and controls input of special characters. For one example, when input of a first special character is detected, the input control processor 210 determines a second special character corresponding to the first special character. Thereafter, the input control processor 210 performs a control operation to display an icon for inputting the second special character through the GUI processor 220. If selection of the icon is sensed, the input control processor 210 inputs the second special character. For another example, when the input of the first special character is detected, the input control processor 210 determines the second special character corresponding to the first special character. Thereafter, the input control processor 210 performs the control operation to display the icon for inputting the second special character through the GUI processor 220. After the icon is displayed, when input of a third character is detected, the input control processor 210 releases the display of the icon. Herein, when the input of the third character is not detected during a reference time, the input control processor 210 displays the icon again.

In addition, when the input of the third character is not detected and the icon is selected, the input control processor 210 may locate a cursor between the first special character and the second special character.

The GUI processor 220 executes the GUI program 114 of the program storing unit 111 and provides a UI as graphics on the display unit 152. For one example, when input of a virtual keyboard is generated through the input control processor 210, the GUI processor 220 performs a control operation to display an input special character on the display unit 152. For another example, the GUI processor 220 may perform a control operation to display an icon for inputting special characters on the display unit 152. For another example, the GUI processor 220 may perform a control operation to display the number of the same characters on the display unit 152.

In one embodiment of the present disclosure, the input control processor 210 of the electronic device 100 executes the input control program 113 and controls character input.

In another embodiment of the present disclosure, the electronic device 100 may include a separate input processing unit including the input control program 113.

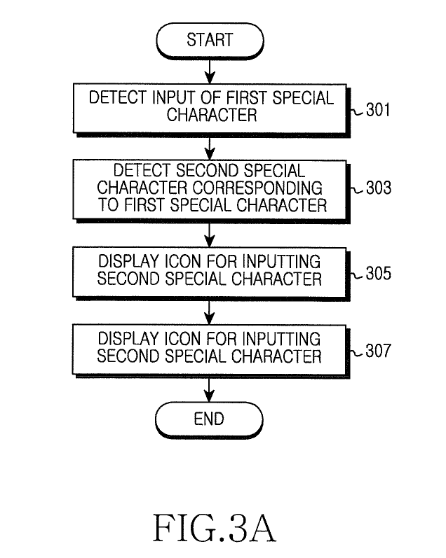

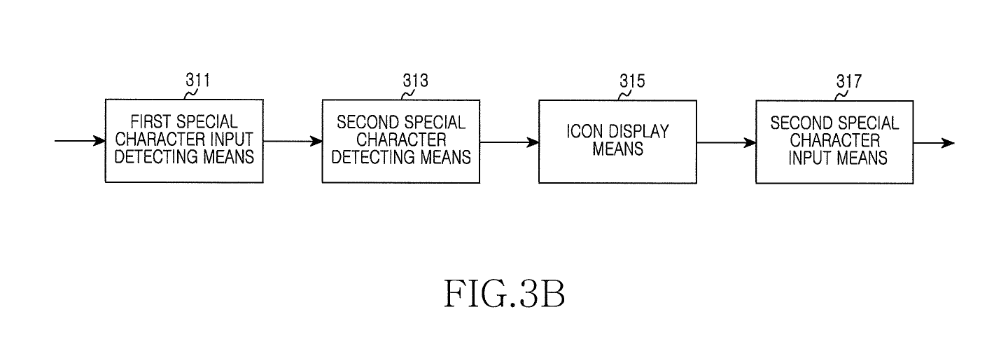

FIG. 3A illustrates a flowchart of a process for inputting special characters which are paired in an electronic device according to one embodiment of the present disclosure.

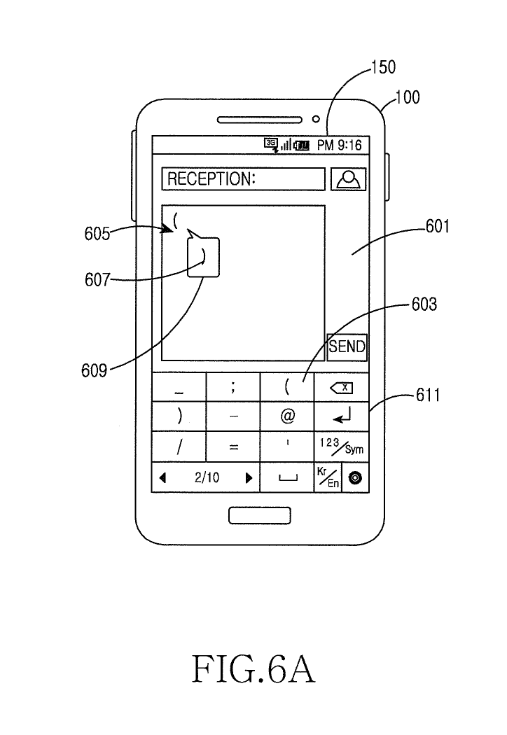

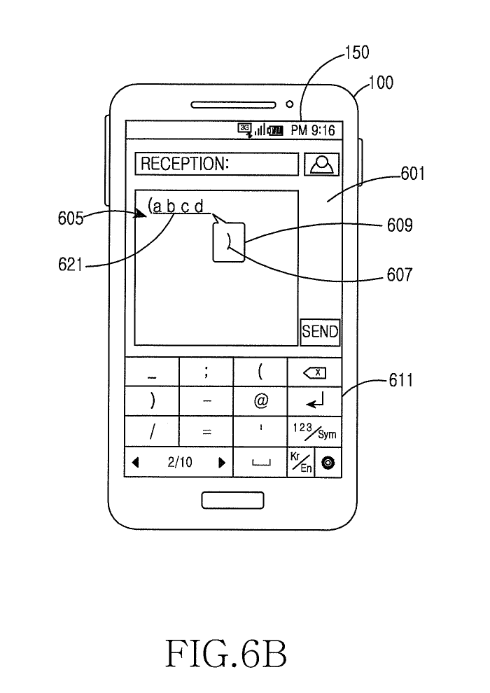

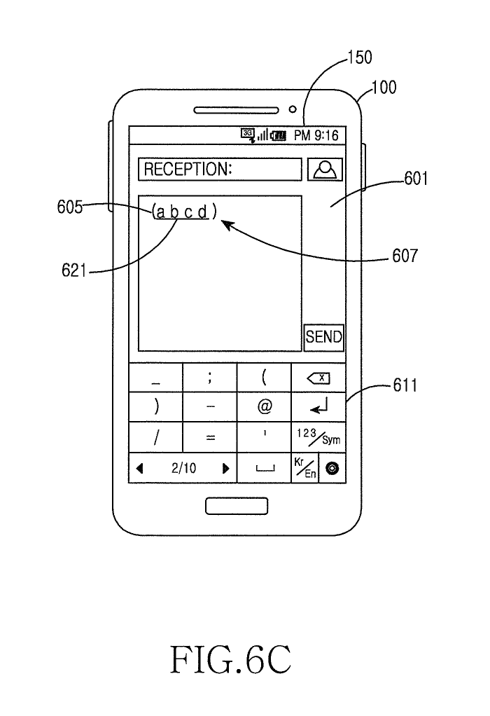

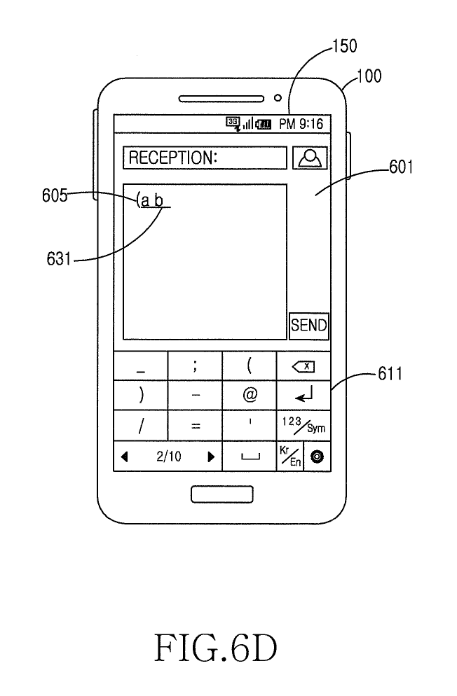

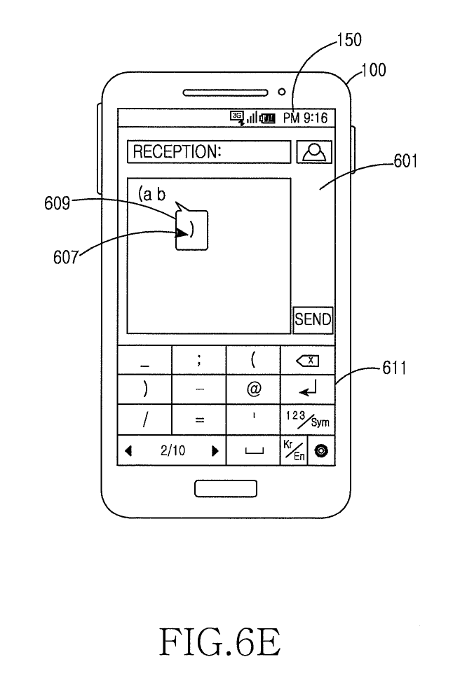

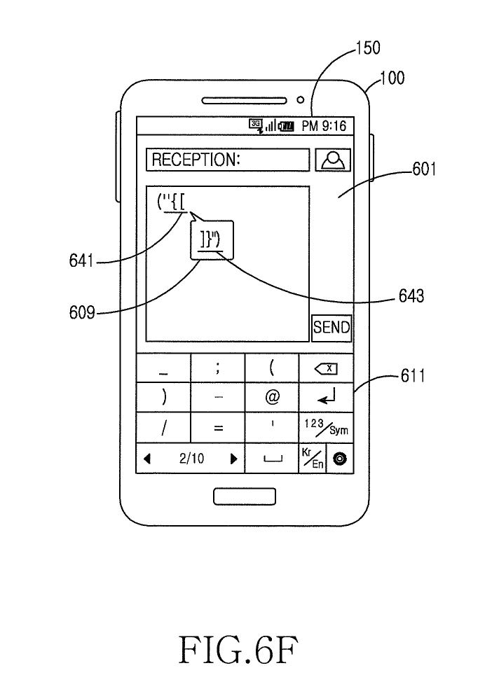

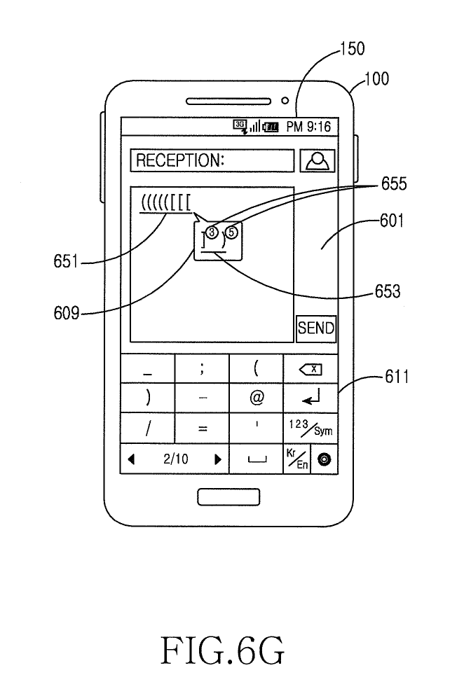

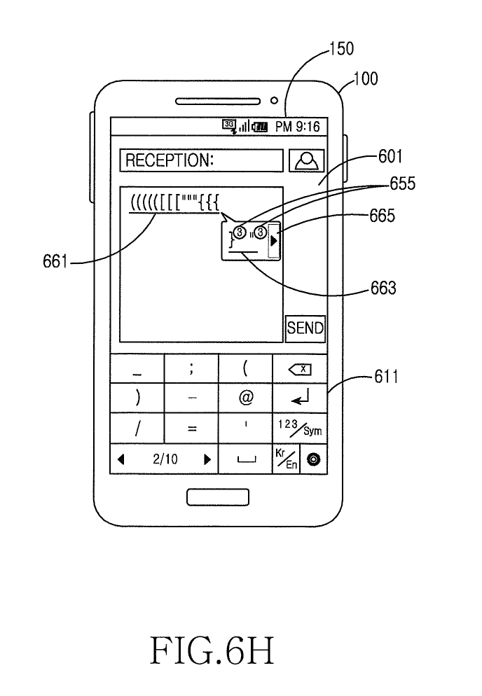

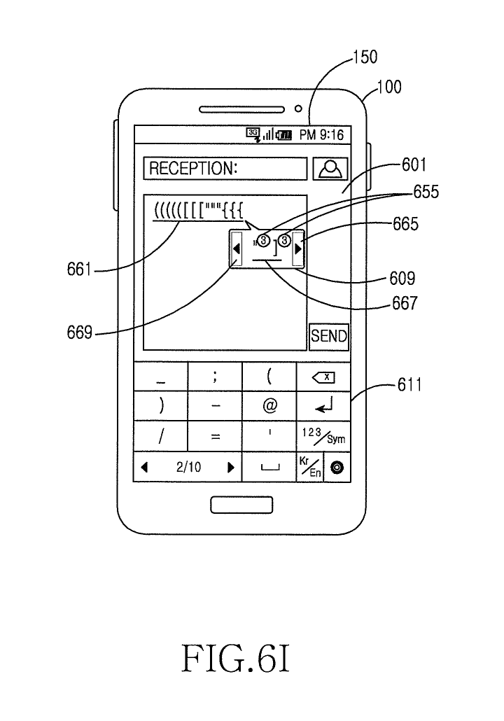

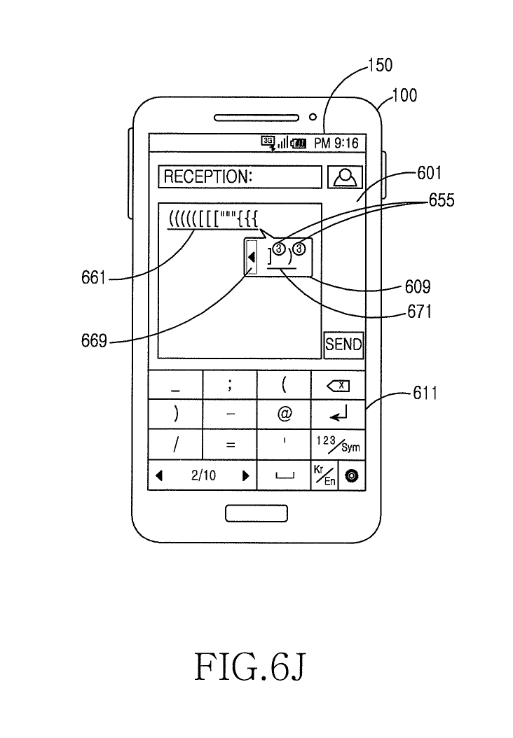

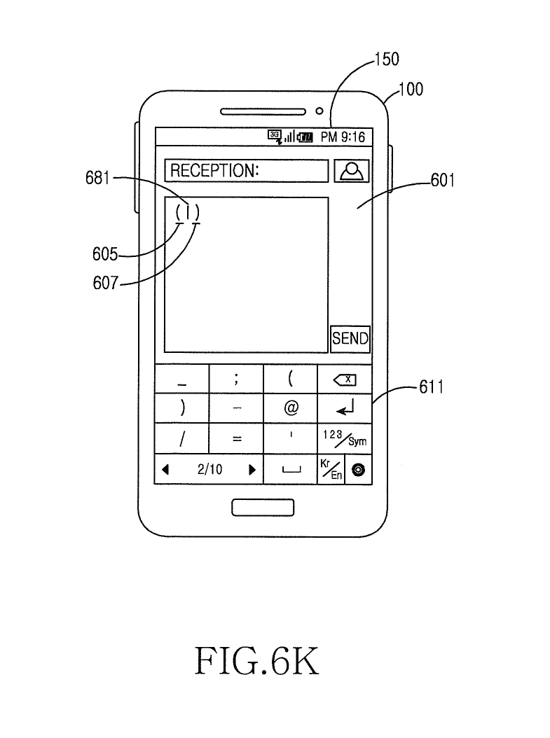

Referring to FIGS. 1 and 3A, the electronic device 100 detects input of a first special character in step 301. For one example, as shown in FIG. 6A, when a key 603 is selected on a virtual keyboard 611 of a message application program 601, the electronic device 100 inputs a special character “(” 605 on an input window of the message application program 601. For another example, the electronic device 100 may input, as shown in FIG. 6F, a plurality of special characters “(“{[” 641.

After the input of the first special character is detected, the electronic device 100 proceeds to step 303 and determines a second special character corresponding to the first special character. For one example, as shown in FIG. 6A, the electronic device 100 verifies whether there is a special character which is paired with the special character “(” 605. Herein, it is assumed that the special characters which are paired include at least one of special characters which are paired and used, such as ( ) { }, [ ], < >, < >, < >, “ ”, ‘ ’, [symbol] , and [symbol] . Also, the special characters which are paired may be set and changed by a user of the electronic device 100.

After the second special character corresponding to the first special character is determined, the electronic device 100 proceeds to step 305 and displays an icon for inputting the second special character. For one example, the electronic device 100 displays a special character “)” 607 which is paired with the special character “(” 605 in a speech bubble 609 on the input window of the message application program 601. For another example, the electronic device 100 may display, as shown in FIG. 6F, a plurality of special characters “] }”)” 643 which are paired with the plurality of special characters “(“{[” 641 in the speech bubble 609. Herein, as shown in FIG. 6G, when special characters “((((([[[” 651 including a plurality of the same special characters are input, the electronic device 100 may display the number 655 of the same special characters in the speech bubble 609. Also, as shown in FIG. 6H, when a plurality of special characters “(((((“““{{{” 661 which have the reference number of special characters or more are input, the electronic device 100 may display special characters “}”” 663 which have the reference number of special characters in the speech bubble 609, display the number 655 of the displayed special characters 663, and has a right arrow button 665 for verifying next special characters which are not displayed. Herein, when the right arrow button 665 is selected, the electronic device 100 may display, as shown in FIG. 6I, special characters “ ”]” 667, display the number 655 of the displayed special characters 667, have a right arrow button 665 for verifying next special characters which are not displayed, and have a left arrow button 669 for verifying previous special buttons which are not displayed. Herein, when the right arrow button 665 is selected, the electronic device 100 may display, as shown in FIG. 6J, special characters “])” 671, display the number 655 of the displayed special characters 671, and have the left arrow button 669 for verifying previous special characters which are not displayed.

After the icon for inputting the second special character is displayed, the electronic device 100 proceeds to step 307 and inputs the second special character when selection of the icon is sensed. For one example, as shown in FIG. 6A, when the special character “)” 607 displayed in the speech bubble 609 is selected, the electronic device 100 inputs, as shown in FIG. 6C, the special character “)” 607 to the input window of the message application program 601. For another example, as shown in FIG. 6A, when the speech bubble 609 is selected, the electronic device 100 may input, as shown in FIG. 6C, the special character “)” 607 to the input window of the message application program 601. Herein, as shown in FIG. 6K, the electronic device 100 may locate a cursor 681 between the first special character 605 and the second special character 607. Also, as shown in FIG. 6F, when the special character “]” is selected in the speech bubble 609, the electronic device 100 may input the special character “]” to the input window of the message application program 601 and display special characters ““}” ” except for the special character “]” in the speech bubble 609. Also, as shown in FIG. 6G, when the special character “]” is selected in the speech bubble 609, the electronic device 100 may input at least one “]” to the input window of the message application program 601 and display special characters except for the at least special character “]” in the speech bubble 609.

Thereafter, the electronic device 100 ends the algorithm of FIG. 3A.

As described above, the process of controlling input of special characters in the electronic device 100 may be configured, as shown in FIG. 3B, an apparatus for controlling input of special characters in the electronic device.

FIG. 3B illustrates a block diagram of an electronic device for inputting special characters which are paired according to one embodiment of the present disclosure.

Referring to FIGS. 1 and 3B, the electronic device 100 may include a first special character input detecting means, that is, a first means 311 for detecting input of a first special character, a second special character determining means, that is, a second means for determining a second special character corresponding to the first special character, an icon display means, that is, a third means 315 for displaying an icon for inputting the second special character, and a second special character input means, that is, a fourth means 317 for inputting the second special character.

The first means 311 detects the input of the first special character. For one example, as shown in FIG. 6A, when a key 603 is selected on a virtual keyboard 611 of a message application program 601, the first means 311 inputs a special character “(” 605 to an input window of the message application program 601. For another example, the first means 311 may input, as shown in FIG. 6F, a plurality of special characters “(“{[” 641.

The second means 313 determines the second special character corresponding to the first special character. For one example, as shown in FIG. 6A, the second means 313 verifies whether there is a special character which is paired with the special character “(” 605. Herein, it is assumed that the special characters which are paired include at least one of special characters which are paired and used, such as ( ), { }, [ ], [ ], < >, < >, < >, “ ”, ‘ ’, [symbol] , [symbol] , and [symbol] . Also, the special characters which are paired may be set and changed by a user of the electronic device 100.

The third means 315 displays the icon for inputting the second special character. For one example, the third means 315 displays a special character “)” 607 which is paired with the special character “(” 605 in a speech bubble 609 on the input window of the message application program 601. For another example, the third means 315 may display, as shown in FIG. 6F, a plurality of special characters “]}”)” 643 which are paired with the plurality of special characters “(“{[” 641 in the speech bubble 609. Herein, as shown in FIG. 6G, when special characters “((((([[[” 651 including a plurality of the same special characters are input, the third means 315 may display the number 655 of the same special characters in the speech bubble 609. Also, as shown in FIG. 6H, when a plurality of special characters “((((([[[”””{{{” 661 which have the reference number of special characters or more are input, the third means 315 may display special characters “}”” 663 which have the reference number of special characters in the speech bubble 609, display the number 655 of the displayed special characters 663, and have a right arrow button 665 for verifying next special characters which are not displayed. Herein, when the right arrow button 665 is selected, the third means 315 may display, as shown in FIG. 6I, special characters “ ”]” 667, display the number 655 of the displayed special characters 667, have a right arrow button 665 for verifying next special characters which are not displayed, and have a left arrow button 669 for verifying previous special buttons which are not displayed. Herein, when the right arrow button 665 is selected, the third means 315 may display, as shown in FIG. 6J, special characters “])” 671, display the number 655 of the displayed special characters 671, and have the left arrow button 669 for verifying previous special characters which are not displayed.

The fourth means 317 inputs the second special character. For one example, as shown in FIG. 6A, when the special character “)” 607 displayed in the speech bubble 609 is selected, the fourth means 317 inputs, as shown in FIG. 6C, the special character “)” 607 to the input window of the message application program 601. For another example, as shown in FIG. 6A, when the speech bubble 609 is selected, the fourth means 317 may input, as shown in FIG. 6C, the special character “)” 607 to the input window of the message application program 601. Herein, as shown in FIG. 6K, the fourth means 317 may locate a cursor 681 between the first special character 605 and the second special character 607. Also, as shown in FIG. 6F, when the special character “]” is selected in the speech bubble 609, the fourth means 317 may input the special character “]” to the input window of the message application program 601 and display special characters “ ”}“)” except for the special character “]” in the speech bubble 609. Also, as shown in FIG. 6G, when the special character “]” is selected in the speech bubble 609, the fourth means 317 may input at least one “3” to the input window of the message application program 601 and display special characters except for the at least special character “3” in the speech bubble 609.

As described above, the electronic device may include means for controlling input of special characters. Herein, the electronic device may include a plurality of means for controlling input of special characters as one means.

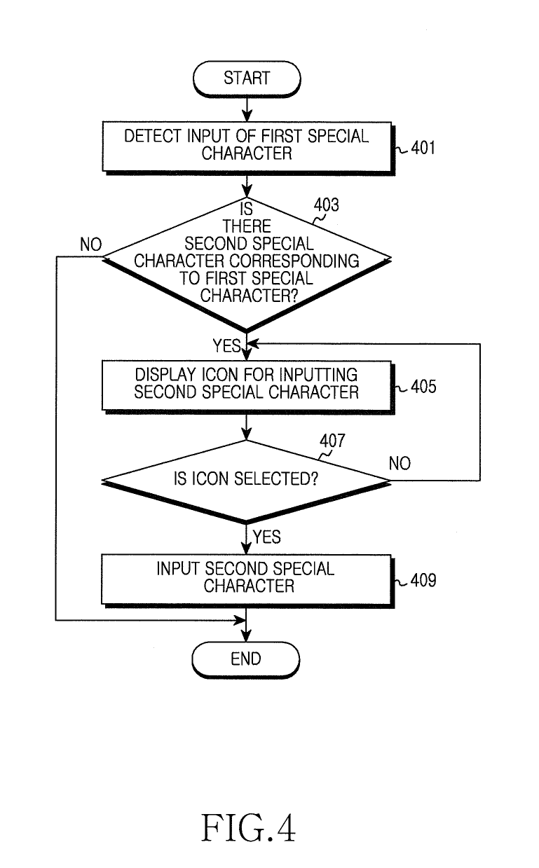

FIG. 4 illustrates a flowchart of a process for inputting special characters which are paired in an electronic device according to another embodiment of the present disclosure.

Referring to FIGS. 1 and 4, the electronic device 100 detects input of a first special character in step 401. For one example, as shown in FIG. 6A, when a key 603 is selected on a virtual keyboard 611 of a message application program 601, the electronic device 100 inputs a special character “(” 605 to an input window of the message application program 601. For another example, the electronic device 100 may input, as shown in FIG. 6F, a plurality of special characters “(“{[” 641.

After the input of the first special character is detected, the electronic device 100 proceeds to step 403 and determines whether there is a second special character corresponding to the first special character. For one example, as shown in FIG. 6A, the electronic device 100 verifies whether there is a special character which is paired with the special character “(” 605. Herein, it is assumed that the special characters which are paired include at least one of special characters which are paired and used, such as ( ), { }, [ ], [ ], < >, < >, < >, “ ”, ‘ ’, [symbol] , and [symbol] . Also, the special characters which are paired may be set and changed by a user of the electronic device 100. When there is no second special character corresponding to the first special character, the electronic device 100 ends the algorithm of FIG. 4.

On the other hand, when there is the second special character corresponding to the first special character, the electronic device 100 proceeds to step 405 and displays an icon for inputting the second special character. For one example, the electronic device 100 displays, as shown in FIG. 6A, a special character “)” 607 which is paired with the special character “(” 605 in a speech bubble 609 on the input window of the message application program 601. For another example, the electronic device 100 may display, as shown in FIG. 6F, a plurality of special characters “] }”)” 643 which are paired with the plurality of special characters “(“{ [” 641 in the speech bubble 609. Herein, as shown in FIG. 6G, when special characters “((((([[[” 651 including a plurality of the same special characters are input, the electronic device 100 may display the number 655 of the same special characters in the speech bubble 609. Also, as shown in FIG. 6H, when a plurality of special characters “((((([[[“““{{{” 661 which have the reference number of special characters or more are input, the electronic device 100 may display special characters “}”” 663 which have the reference number of special characters in the speech bubble 609, display the number 655 of the displayed special characters 663, and have a right arrow button 665 for verifying next special characters which are not displayed. Herein, when the right arrow button 665 is selected, the electronic device 100 may display, as shown in FIG. 6I, special characters “}”” 667, display the number 655 of the displayed special characters 667, have a right arrow button 665 for verifying next special characters which are not displayed, and have a left arrow button 669 for verifying previous special buttons which are not displayed. Herein, when the right arrow button 665 is selected, the electronic device 100 may display, as shown in FIG. 6J, special characters “])” 671, display the number 655 of the displayed special characters 671, and have the left arrow button 669 for verifying previous special characters which are not displayed.

After the icon for inputting the second special character is displayed, the electronic device 100 proceeds to step 407 and verifies whether the icon is selected. For one example, as shown in FIG. 6A, the electronic device 100 verifies whether the special character “)” 607 displayed in the speech bubble 609 is selected. Herein, when the speech bubble 609 is selected, the electronic device 100 may recognize that the special character “)” 607 displayed in the speech bubble 609 is selected. If the icon is not selected, the electronic device 100 proceeds to step 405 and displays the icon for inputting the second special character.

When the icon is selected, the electronic device 100 proceeds to step 409 and inputs the second special character. For one example, when the special character “)” 607 displayed in the speech bubble 609 is selected, the electronic device 100 inputs, as shown in FIG. 6C, the special character “)” 607 to the input window of the message application program 601. For another example, as shown in FIG. 6A, when the speech bubble 609 is selected, the electronic device 100 may input, as shown in FIG. 6C, the special character “)” 607 to the input window of the message application program 601. Herein, as shown in FIG. 6K, the electronic device 100 may locate a cursor 681 between the first special character 605 and the second special character 607. Also, as shown in FIG. 6F, when the special character “]” is selected in the speech bubble 609, the electronic device 100 may input the special character “]” to the input window of the message application program 601 and display special characters ““}”)” except for the special character “]” in the speech bubble 609. Also, as shown in FIG. 6G, when the special character “]” is selected in the speech bubble 609, the electronic device 100 may input at least one “]” to the input window of the message application program 601 and display special characters except for the at least special character “]” in the speech bubble 609.

Thereafter, the electronic device 100 ends the algorithm of FIG. 4.

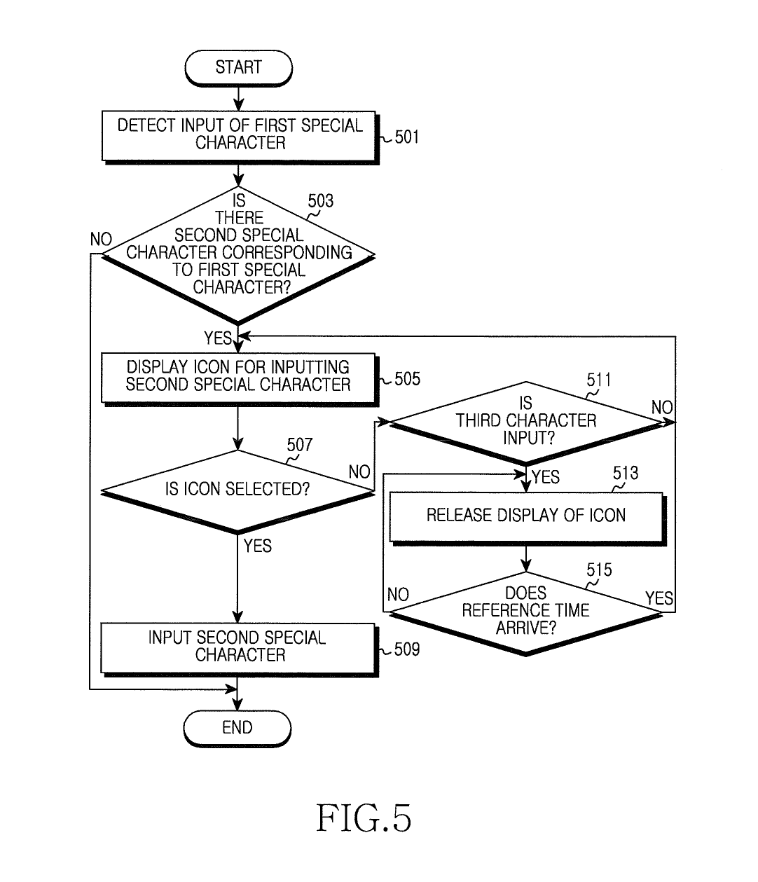

FIG. 5 illustrates a flowchart of a process for inputting special characters which are paired in an electronic device according to another embodiment of the present disclosure.

Referring to FIGS. 1 and 5, the electronic device 100 detects input of a first special character in step 501. For one example, as shown in FIG. 6A, when a key 603 is selected on a virtual keyboard 611 of a message application program 601, the electronic device 100 inputs a special character “(” 605 to an input window of the message application program 601. For another example, the electronic device 100 may input, as shown in FIG. 6F, a plurality of special characters “(“{[” 641.

After the input of the first special character is detected, the electronic device 100 proceeds to step 503 and determines whether there is a second special character corresponding to the first special character. For one example, as shown in FIG. 6A, the electronic device 100 verifies whether there is a special character which is paired with the special character “(” 605. Herein, it is assumed that the special characters which are paired include at least one of special characters which are paired and used, such as ( ), { }, [ ], [ ], < >, < >, < >, “ ”, ‘ ’, [symbol] , [symbol] . Also, the special characters which are paired may be set and changed by a user of the electronic device 100. When there is no second special character corresponding to the first special character, the electronic device 100 ends the algorithm of FIG. 5.

On the other hand, when there is the second special character corresponding to the first special character, the electronic device 100 proceeds to step 505 and displays an icon for inputting the second special character. For one example, the electronic device 100 displays, as shown in FIG. 6A, a special character “)” 607 which is paired with the special character “(”605 in a speech bubble 609 on the input window of the message application program 601. For another example, the electronic device 100 may display, as shown in FIG. 6F, a plurality of special characters “] }”)” 643 which are paired with the plurality of special characters “(“{[” 641 in the speech bubble 609. Herein, as shown in FIG. 6G, when special characters “((((([[[” 651 including a plurality of the same special characters are input, the electronic device 100 may display the number 655 of the same special characters in the speech bubble 609. Also, as shown in FIG. 6H, when a plurality of special characters “((((([[[”””{{{” 661 which have the reference number of special characters or more are input, the electronic device 100 may display special characters “}”” 663 which have the reference number of special characters in the speech bubble 609, display the number 655 of the displayed special characters 663, and have a right arrow button 665 for verifying next special characters which are not displayed. Herein, when the right arrow button 665 is selected, the electronic device 100 may display, as shown in FIG. 6I, special characters “]” 667, display the number 655 of the displayed special characters 667, have a right arrow button 665 for verifying next special characters which are not displayed, and have a left arrow button 669 for verifying previous special buttons which are not displayed. Herein, when the right arrow button 665 is selected, the electronic device 100 may display, as shown in FIG. 6J, special characters “])” 671, display the number 655 of the displayed special characters 671, and have the left arrow button 669 for verifying previous special characters which are not displayed.

After the icon for inputting the second special character is displayed, the electronic device 100 proceeds to step 507 and verifies whether the icon is selected. For one example, as shown in FIG. 6A, the electronic device 100 verifies whether the special character “)” 607 displayed in the speech bubble 609 is selected. Herein, when the speech bubble 609 is selected, the electronic device 100 may recognize that the special character “)” 607 displayed in the speech bubble 609 is selected.

When the icon is selected, the electronic device 100 proceeds to step 509 and inputs the second special character. For one example, as shown in FIG. 6A, when the special character “)” 607 displayed in the speech bubble 609 is selected, the electronic device 100 inputs, as shown in FIG. 6C, the special character “)” 607 to the input window of the message application program 601. For another example, as shown in FIG. 6A, when the speech bubble 609 is selected, the electronic device 100 may input, as shown in FIG. 6C, the special character “)” 607 to the input window of the message application program 601. Herein, as shown in FIG. 6K, the electronic device 100 may locate a cursor 681 between the first special character 605 and the second special character 607. Also, as shown in FIG. 6F, when the special character “]” is selected in the speech bubble 609, the electronic device 100 may input the special character “]” to the input window of the message application program 601 and display special characters ““}”)” except for the special character “]” in the speech bubble 609. Also, as shown in FIG. 6G, when the special character “]” is selected in the speech bubble 609, the electronic device 100 may input at least one “]” to the input window of the message application program 601 and display special characters except for the at least special character “]” in the speech bubble 609.

On the other hand, when the icon is not selected, the electronic device 100 proceeds to step 511 and verifies whether a third character is input. If the third character is not input, the electronic device 100 proceeds to step 505 and displays the icon for inputting the second special character.

On the other hand, when the third character is input, the electronic device 100 proceeds to step 513 and releases the display of the icon for inputting the second special character. For example, as shown in FIG. 6D, when special characters “ [symbol] ” 631 is input, the electronic device 100 releases the display of the special character “)” 607.

After the display of the icon is released, the electronic device 100 proceeds to step 515 and verifies whether a reference time for displaying the icon arrives. When the reference time for displaying the icon for inputting the second special character arrives, the electronic device 100 proceeds to step 505 and displays the icon for inputting the second special character. For example, as shown in FIG. 6D, after the special characters “ [symbol] ” 631 are input, when the reference time arrives, the electronic device 100 displays, as shown in FIG. 6E, the special character “)” 607 again.

On the other hand, when the reference time for displaying the icon does not arrive, the electronic device 100 proceeds to step 513 and maintains the release of the display of the icon.

Thereafter, the electronic device 100 ends the algorithm of FIG. 5.

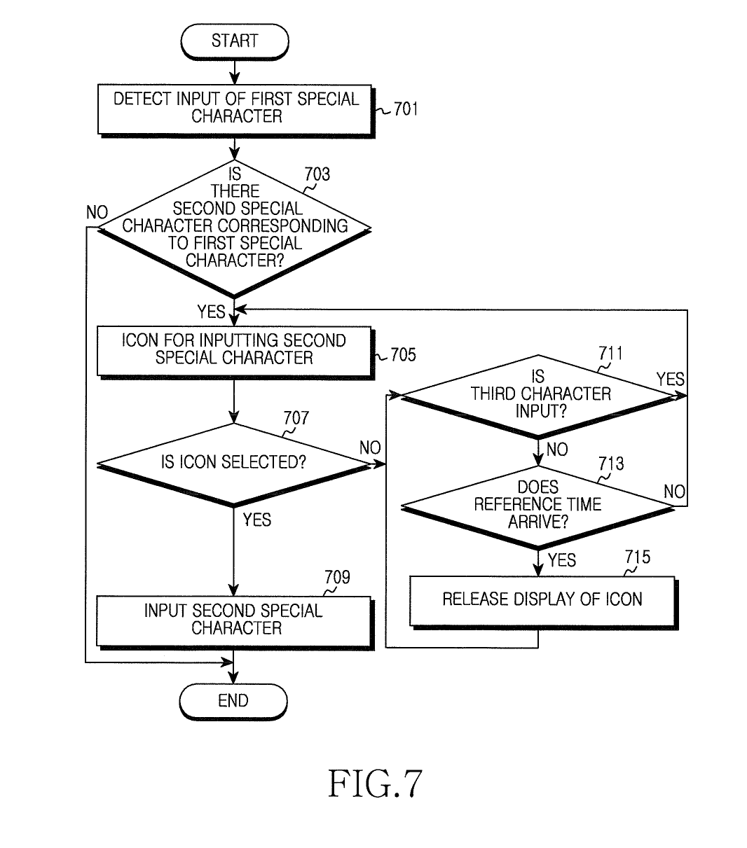

FIG. 7 illustrates a flowchart of a process for inputting special characters which are paired in an electronic device according to another embodiment of the present disclosure.

Referring to FIGS. 1 and 7, the electronic device 100 detects input of a first special character in step 701. For one example, as shown in FIG. 6A, when a key 603 is selected on a virtual keyboard 611 of a message application program 601, the electronic device 100 inputs a special character “(” 605 to an input window of the message application program 601. For another example, the electronic device 100 may input, as shown in FIG. 6F, a plurality of special characters “(“{[” 641.

After the input of the first special character is detected, the electronic device 100 proceeds to step 703 and determines whether there is a second special character corresponding to the first special character. For one example, as shown in FIG. 6A, the electronic device 100 verifies whether there is a special character which is paired with the special character “(” 605. Herein, it is assumed that the special characters which are paired include at least one of special characters which are paired and used, such as ( ) { }, [ ], [ ], < >, < >, < >, “ ”, ‘ ’, [symbol] , and [symbol] . Also, the special characters which are paired may be set and changed by a user of the electronic device 100. When there is no second special character corresponding to the first special character, the electronic device 100 ends the algorithm of FIG. 7.

On the other hand, when there is the second special character corresponding to the first special character, the electronic device 100 proceeds to step 705 and displays an icon for inputting the second special character. For one example, the electronic device 100 displays, as shown in FIG. 6A, a special character “)” 607 which is paired with the special character “(” 605 in a speech bubble 609 on the input window of the message application program 601. For another example, the electronic device 100 may display, as shown in FIG. 6F, a plurality of special characters “]}”)” 643 which are paired with the plurality of special characters “(“{[” 641 in the speech bubble 609. Herein, as shown in FIG. 6G, when special characters “((((([[[” 651 including a plurality of the same special characters are input, the electronic device 100 may display the number 655 of the same special characters in the speech bubble 609. Also, as shown in FIG. 6H, when a plurality of special characters “((((([[[“““{{{” 661 which have the reference number of special characters or more are input, the electronic device 100 may display special characters “}”” 663 which have the reference number of special characters in the speech bubble 609, display the number 655 of the displayed special characters 663, and have a right arrow button 665 for verifying next special characters which are not displayed. Herein, when the right arrow button 665 is selected, the electronic device 100 may display, as shown in FIG. 6I, special characters “ ”]” 667, display the number 655 of the displayed special characters 667, have a right arrow button 665 for verifying next special characters which are not displayed, and have a left arrow button 669 for verifying previous special buttons which are not displayed. Herein, when the right arrow button 665 is selected, the electronic device 100 may display, as shown in FIG. 6J, special characters “])” 671, display the number 655 of the displayed special characters 671, and have the left arrow button 669 for verifying previous special characters which are not displayed.

After the icon for inputting the second special character is displayed, the electronic device 100 proceeds to step 707 and verifies whether the icon is selected. For one example, as shown in FIG. 6A, the electronic device 100 verifies whether the special character “)” 607 displayed in the speech bubble 609 is selected. Herein, when the speech bubble 609 is selected, the electronic device 100 may recognize that the special character “)” 607 displayed in the speech bubble 609 is selected.

When the icon is selected, the electronic device 100 proceeds to step 709 and inputs the second special character. For one example, as shown in FIG. 6A, when the special character “)” 607 displayed in the speech bubble 609 is selected, the electronic device 100 inputs, as shown in FIG. 6C, the special character “)” 607 to the input window of the message application program 601. For another example, as shown in FIG. 6A, when the speech bubble 609 is selected, the electronic device 100 may input, as shown in FIG. 6C, the special character “)” 607 to the input window of the message application program 601. Herein, as shown in FIG. 6K, the electronic device 100 may locate a cursor 681 between the first special character 605 and the second special character 607. Also, as shown in FIG. 6F, when the special character “]” is selected in the speech bubble 609, the electronic device 100 may input the special character “]” to the input window of the message application program 601 and display special characters ““}”)” except for the special character “]” in the speech bubble 609. Also, as shown in FIG. 6G, when the special character “]” is selected in the speech bubble 609, the electronic device 100 may input at least one “]” to the input window of the message application program 601 and display special characters except for the at least special character “]” in the speech bubble 609.

On the other hand, when the icon is not selected, the electronic device 100 proceeds to step 711 and verifies whether a third character is input. If the third character is input, the electronic device 100 proceeds to step 705 and continuously displays the icon for inputting the second special character. For example, as shown in FIG. 6D, when special characters “ [symbol] ” 631 are input, the electronic device 100 displays, as shown in FIG. 6E, the special character “)” 607 continuously.

On the other hand, when the third character is not input, the electronic device 100 proceeds to step 713 and verifies whether a reference time for releasing the display of the icon arrives. When the reference time for releasing the display of the icon does not arrive, the electronic device 100 proceeds to step 705 and continuously displays the icon for inputting the second special character.

On the other hand, when the reference time for releasing the display of the icon arrives, the electronic device 100 proceeds to step 715 and releases the display of the icon for inputting the second special character. After the display of the icon is released, the electronic device 100 proceeds to step 711 and verifies whether the third character is input.

Thereafter, the electronic device 100 ends the algorithm of FIG. 7.

As described above, the electronic device may allow the user to input special characters easily by automatically displaying and inputting special characters which are paired.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method of operating an electronic device, the method comprising:
detecting input of at least one first special character;
determining at least one second special character corresponding to the at least one first special character;
displaying the at least one second special character; and
inputting the at least one second special character in response to sensing selection of the at least one second special character.

2. The method of claim 1, wherein the first special character and the second special character include special characters which are paired and used together.

3. The method of claim 1, further comprising displaying an icon for inputting the at least one second special character.

4. The method of claim 3, further comprising releasing display of the icon in response to sensing the selection of the icon.

5. The method of claim 1, wherein displaying the at least one second special character comprises displaying the at least one second special character on a right side of the first special character.

6. The method of claim 1, wherein displaying the at least one second special character comprises displaying one of a plurality of second special characters that correspond to each of a plurality of first special characters, if the at least one first special character is the plurality of first special characters.

7. The method of claim 6, wherein displaying the at least one second special character comprises displaying a number of same special characters among the plurality of second special characters.

8. The method of claim 1, further comprising:
releasing display of the at least one second special character in response to input of a third character being detected after the at least one second special character is displayed; and
displaying the at least one second special character, when input of a character is not detected during a reference time after the display of the at least one second special character is released.

9. The method of claim 1, further comprising changing and displaying a position of the at least one second special character in a right direction of a third character in response to input of the third character being detected after the at least one second special character is displayed.

10. A method of inputting special characters in an electronic device, the method comprising:
detecting input of at least one first special character;
determining at least one second special character corresponding to the at least one first special character;
inputting the at least one second special character; and
displaying a cursor between the at least one first special character and the at least one second special character.

11. The method of claim 10, further comprising changing and displaying a position of the at least one second special character in a right direction of a third character in response to input of the third character being detected on a position where the cursor is displayed.

12. An electronic device comprising:
at least one processor;
at least one memory configured to store at least one program, wherein the at least one processor is configured to execute program code of the at least one program to:
detect input of at least one first special character,
determine at least one second special character corresponding to the at least one first special character,
control a display to display the at least one second special character, and
input the at least one second special character in response to sensing selection of the at least one second special character.

13. The electronic device of claim 12, wherein the first special character and the second special character include special characters which are paired and used together.

14. The electronic device of claim 12, wherein the at least one processor is configured to control the display a icon for inputting the at least one second special character.

15. The electronic device of claim 14, wherein the at least one processor is configured to control the display to release the display of the icon when the selection of the icon is sensed.

16. The electronic device of claim 12, wherein the at least one processor is configured to control the display to display the at least one second special character on a right side of the first special character.

17. The electronic device of claim 12, wherein the at least one processor is configured to control the display to display one of a plurality of second special characters correspond to each of a plurality of first special characters, if the at least one first special character is the plurality of first special characters.

18. The electronic device of claim 17, wherein the at least one processor is configured to control the display to display a number of same special characters among the plurality of second special characters.

19. The electronic device of claim 12, wherein the at least one processor is configured to control the display to release display of the at least one second special character in response to input of a third character being detected after the at least one second special character is displayed and display the at least one second special character, when input of a character is not detected during a reference time after the display of the at least one second special character is released.

20. The electronic device of claim 12, wherein the at least one processor is configured to control the display to change and display a position of the at least one second special character in a right direction of a third character in response to input of the third character being detected after the at least one second special character is displayed.

21. An electronic device comprising:
at least one processor;
at least one memory configured to store at least one program, wherein the at least one processor is configured to execute program code of the at least one program to:
detect input of at least one first special character,
determine at least one second special character corresponding to the at least one first special character,
input the at least one second special character, and
control a display to display a cursor between the at least one first special character and the at least one second special character.

22. The electronic device of claim 21, wherein the at least one processor is configured to control the display to change and display a position of the at least one second special character in a right direction of a third character in response to input of the third character being detected on a position where the cursor is displayed.
